(19) United States
(12) Patent Application Publication
(10) Pub. No.: US 2016/0366259 A1
(43) Pub. Date: Dec. 15, 2016

(54) Adaptive Audio in Modular Portable Electronic Device

(71) Applicant: Motorola Mobility LLC, Chicago, IL (US)

(72) Inventors: Michael J. Lombardi, Lake Zurich, IL (US); Joseph L. Allore, Mundelein, IL (US); Paul Fordham, Wauconda, IL (US)

(21) Appl. No.: 14/737,990

(22) Filed: Jun. 12, 2015

(51) Int. Cl. H04M 1/60

(52) U.S. Cl. CPC H04M 1/6041

(57) ABSTRACT

A modular device system includes a base device and additional functionality modules that are separately dockable to the base device to form a single device. The base device includes one or more speakers and one or more microphones. For each device, its multiple speakers and microphones are driven independently of the other device when the devices are not docked together. However, when one of the additional functionality modules is docked to the base device, a predetermined optimized audio configuration specific to the particular additional functionality module is set for the combined device.

### TECHNICAL FIELD

The present disclosure is related generally to modular mobile communication devices, and, more particularly, to a system and method for adaptively changing audio settings depending upon characteristics of one or more modules.

### BACKGROUND

Among the many uses for modern cellular phones, audio play and playback remain primary applications. For example, while texting has replaced many voice calls, texting remains impractical when either party is driving or otherwise engaged with their eyes or hands. In addition, many consumers do not even maintain a landline anymore, choosing instead to use their cellular phone for all voice calls. In addition, the widespread use of portable phones for both business and entertainment means that such devices must support suitable audio to adequately replay music and video material, host private and speakerphone calls, and so on.

However, in a modular device system, i.e., where two independent devices attach to each other to form a single combined device, each device's presence may affect the audio quality of the other device. For example, the act of docking the devices together may obscure a speaker on one or both devices. Similarly, a noise cancellation mic of a first device may be obscured upon docking with a second device, negatively impacting audio quality for a call on the first device. The foregoing examples are not exhaustive of course, and it will be appreciated that there are many situations in which docking devices together in a modular system may have a negative impact on the audio quality of either device.

While the present disclosure is directed to a system that can eliminate certain shortcomings noted above, it should be appreciated that such a benefit is neither a limitation on the scope of the disclosed principles nor of the attached claims, except to the extent expressly noted in the claims. Additionally, the discussion of technology in this Background section is reflective of the inventors' own observations, considerations, and thoughts, and is in no way intended to accurately catalog or comprehensively summarize the art in the public domain. As such, the inventors expressly disclaim this section as admitted or assumed prior art with respect to the discussed details. Moreover, the identification herein of a desirable course of action reflects the inventors' own observations and ideas, and should not be assumed to indicate an art-recognized desirability.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a simplified schematic of an example configuration of device components with respect to which embodiments of the presently disclosed principles may be implemented;

FIG. 2 is view of a first device and a second device, showing the back of the first device and the front of the second device in accordance with an embodiment of the disclosed principles;

FIG. 3 is a side view of the first device and the second device of FIG. 1 in accordance with an embodiment of the disclosed principles;

FIG. 4 is side view of the first device and the second device mated together via the back of the first device and the front of the second device in accordance with an embodiment of the disclosed principles;

FIG. 5 is a flow chart illustrating a process of portable device audio configuration in a modular environment in accordance with an embodiment of the disclosed principles.

### DETAILED DESCRIPTION

Before presenting a fuller discussion of the disclosed principles, an overview is given to aid the reader in understanding the later discussion. As noted, while a modular device architecture provides many benefits observed by the inventors, such a design also raises the likelihood that one device will interfere with the audio quality yielded by the other device. Indeed, both devices may affect each other after docking

In an embodiment of the disclosed principles, the modular device system comprises multiple independent devices. The group of independent devices includes a base device, referred to as a first device, and multiple functionality modules, referred to as second devices, e.g., an enhanced audio module, an enhanced photography module, and so on. Each of the second devices is combinable with the base device to form a single device.

In a further embodiment, the base device includes one or more speakers and one or more microphones. For example, the base device includes, in this embodiment, multiple loudspeakers and multiple microphones. Similarly, an added functionality module includes multiple loudspeakers and multiple microphones. For each device, its multiple loudspeakers and microphones are driven independently of the other device when the devices are not docked together.

However, when the added functionality module is docked to the base module, speakers and microphones on both devices may be obscured or otherwise fail to function properly due to the proximity of the other device. However, in an embodiment, a predetermined optimized audio configuration is established for the combined device when the base device detects that the added functionality module has been docked.

The predetermined optimized audio configuration includes one or more audio settings. For example, an audio configuration may include disabling a rear facing noise cancellation microphone on the base device while enabling a rear facing noise cancellation microphone on the added functionality module, disabling one or more loudspeakers on the base device for speakerphone mode while enabling one or more loudspeakers on the added functionality device, and modifying playback frequencies for the loudspeakers to direct high frequencies to the loudspeakers of one device and to direct low frequencies to the loudspeakers of the other device.

In an embodiment, in order to facilitate the selection of an appropriate predetermined optimized audio configuration, the base device determines a device ID of the added device upon docking The base device then uses the determined device ID to select the correct configuration. In a further embodiment, the device ID allows a look-up in a local or remote configuration table. In an alternative further embodiment, the device ID itself specifies the required configuration.

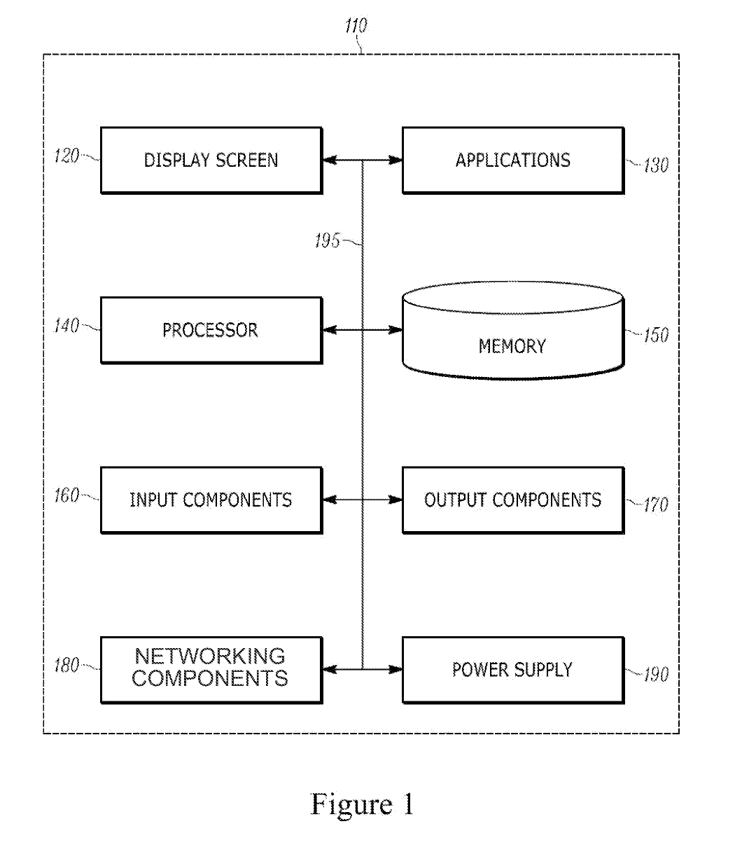

With this overview in mind, and turning now to a more detailed discussion in conjunction with the attached figures, the techniques of the present disclosure are illustrated as being implemented in a suitable computing environment. The following device description is based on embodiments and examples of the disclosed principles and should not be taken as limiting the claims with regard to alternative embodiments that are not explicitly described herein. Thus, for example, while FIG. 1 illustrates an example mobile device within which embodiments of the disclosed principles may be implemented, it will be appreciated that other device types may be used, including but not limited to personal computers, tablet computers and other devices.

The schematic diagram of FIG. 1 shows an exemplary component group 110 forming part of an environment within which aspects of the present disclosure may be implemented. In particular, the component group 110 includes exemplary components that may be employed in a device corresponding to the first device and/or the second device. It will be appreciated that additional or alternative components may be used in a given implementation depending upon user preference, component availability, price point, and other considerations.

In the illustrated embodiment, the components 110 include a display screen 120, applications (e.g., programs) 130, a processor 140, a memory 150, one or more input components 160 such as speech and text input facilities, and one or more output components 170 such as text and audible output facilities, e.g., one or more speakers.

The processor 140 may be any of a microprocessor, microcomputer, application-specific integrated circuit, or the like. For example, the processor 140 can be implemented by one or more microprocessors or controllers from any desired family or manufacturer. Similarly, the memory 150 may reside on the same integrated circuit as the processor 140. Additionally or alternatively, the memory 150 may be accessed via a network, e.g., via cloud-based storage. The memory 150 may include a random access memory (i.e., Synchronous Dynamic Random Access Memory (SDRAM), Dynamic Random Access Memory (DRAM), RAMBUS Dynamic Random Access Memory (RDRM) or any other type of random access memory device). Additionally or alternatively, the memory 150 may include a read only memory (i.e., a hard drive, flash memory or any other desired type of memory device).

The information that is stored by the memory 150 can include program code associated with one or more operating systems or applications as well as informational data, e.g., program parameters, process data, etc. The operating system and applications are typically implemented via executable instructions stored in a non-transitory computer readable medium (e.g., memory 150) to control basic functions of the electronic device. Such functions may include, for example, interaction among various internal components and storage and retrieval of applications and data to and from the memory 150.

Further with respect to the applications 130, these typically utilize the operating system to provide more specific functionality, such as file system service and handling of protected and unprotected data stored in the memory 150. Although many applications may provide standard or required functionality of the user device 110, in other cases applications provide optional or specialized functionality, and may be supplied by third party vendors or the device manufacturer.

Finally, with respect to informational data, e.g., program parameters and process data, this non-executable information can be referenced, manipulated, or written by the operating system or an application. Such informational data can include, for example, data that are preprogrammed into the device during manufacture, data that are created by the device or added by the user, or any of a variety of types of information that are uploaded to, downloaded from, or otherwise accessed at servers or other devices with which the device is in communication during its ongoing operation.

The device having component group 110 may include software and hardware networking components 180 to allow communications to and from the device. Such networking components 180 will typically provide wireless networking functionality, although wired networking may additionally or alternatively be supported.

In an embodiment, a power supply 190, such as a battery or fuel cell, may be included for providing power to the device and its components 110. All or some of the internal components 110 communicate with one another by way of one or more shared or dedicated internal communication links 195, such as an internal bus.

In an embodiment, the device 110 is programmed such that the processor 140 and memory 150 interact with the other components of the device 110 to perform certain functions. The processor 140 may include or implement various modules and execute programs for initiating different activities such as launching an application, transferring data, and toggling through various graphical user interface objects (e.g., toggling through various display icons that are linked to executable applications).

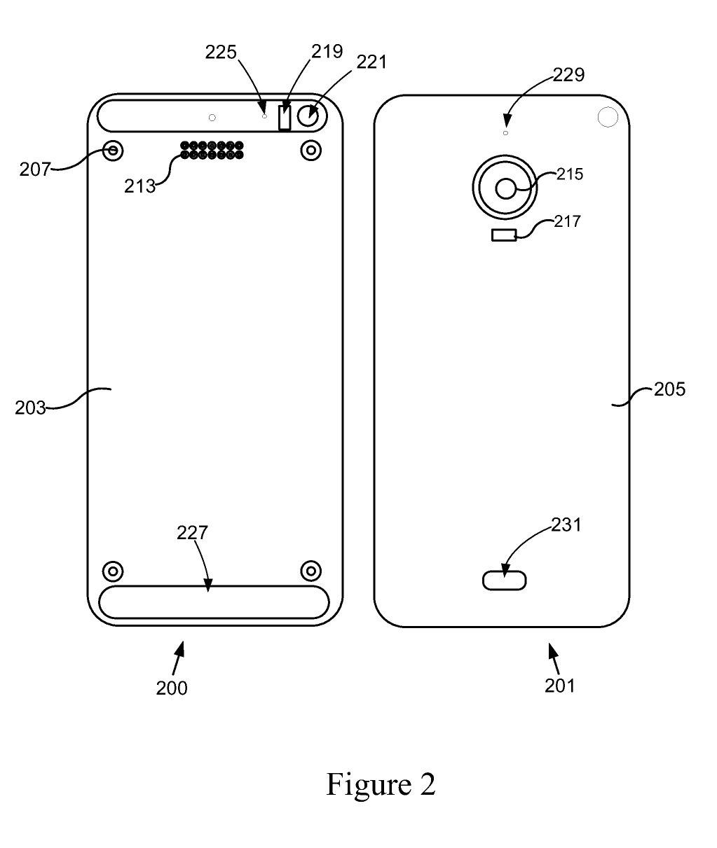

Turning to FIG. 2, this figure illustrates a view of a first device 200 (a base device) and a second device 201 (an added functionality module). In the illustrated embodiment, the back 203 of the first device 200 is the non-display side of the device 200. Also shown is the front 205 of the second device 201 in accordance with an embodiment of the disclosed principles. The back 203 of the first device 200 may include one or more alignment features 207 configured and placed to mate with mating features on the second device 201. Alternatively, any other suitable system may be used to align the devices 200, 201 for docking and to retain them in the docked configuration.

For data communication between the devices, the first device 200 includes a connector array 213 in an embodiment of the disclosed principles. The connector array 205 may be located and configured to mate with a mating connector array on the second device 201.

In the illustrated example, the first device 200 includes a camera 219 and flash 221 that provides basic photography functionality. The second device 201 includes a more capable camera 215 and an associated flash 217 as well to provide extended photography functionality. While the illustrated second device 201 is an extended photography functionality module, it will be appreciated that any other type of second device may instead be used without departing from the scope of the disclosed principles.

To enable audio interaction with the user, the first and second devices 200, 201 include earpiece speakers, loudspeakers and microphones as noted above. In an embodiment, these features include a microphone 225 and loudspeaker 227 on the first device 200, as well as a microphone 229 and loudspeaker 231 on the second device 201.

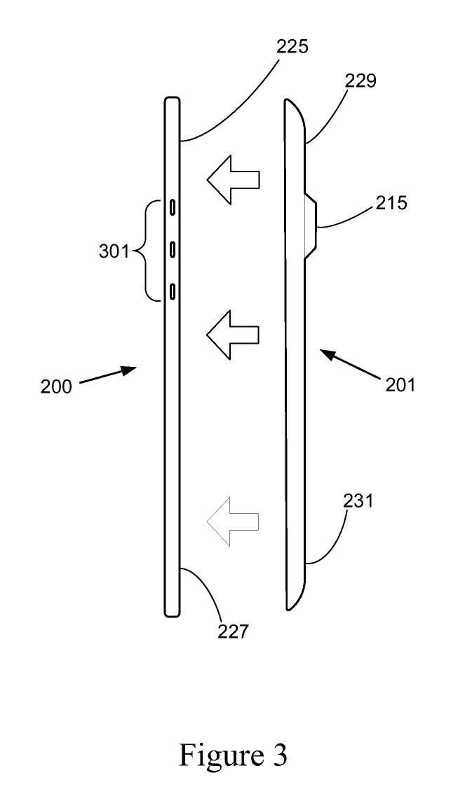

FIG. 3 is a simplified side view of the first device 200 and the second device 201, not yet mated (docked) together. In this view, the locations of the microphone 225 and loudspeaker 227 on the first device 200, and microphone 229 and loudspeaker 231 on the second device 201 are shown. In addition, certain user-selectable buttons 301 are shown. These buttons 400 may include volume control buttons, power buttons, user interface control buttons and so on.

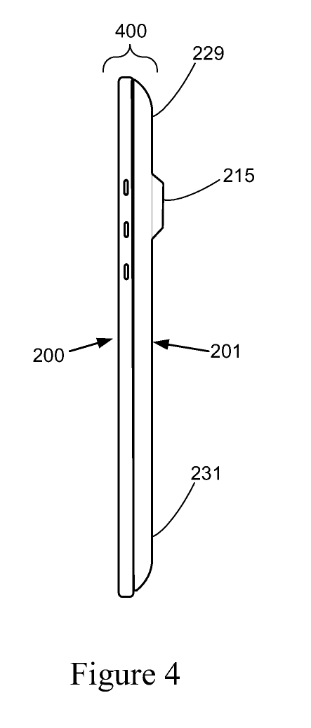

Continuing, FIG. 4 is a simplified side view of the first device 200 and the second device 201 mated together in accordance with an embodiment of the disclosed principles. As can be seen, the devices 200, 201 are in physical contact when mated, and the microphone 225 and loudspeaker 227 of the first device 200 are covered by the second device 201.

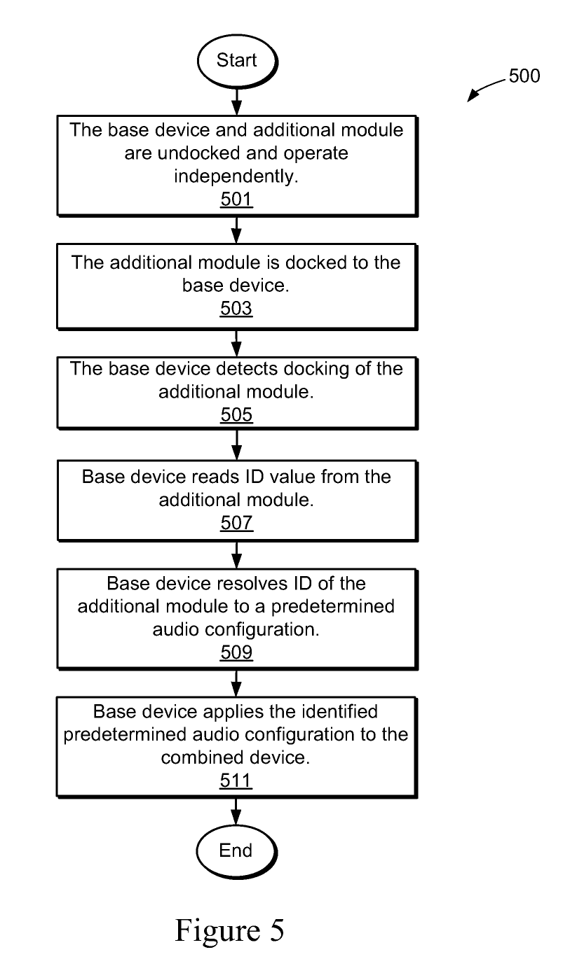

To counter this occurrence, a predetermined optimized audio configuration is established for the combined device 400, in an embodiment, when the base device 200 detects that the added functionality module 201 has been docked. The flow chart of FIG. 5 describes the audio configuration process 500 in greater detail.

While the process 500 is described through actions of the first device 200, it will be appreciated that the first device 200 acts via its processor 140. In particular, the processor 140 of the first device 200 executes computer-readable instructions that are read from a non-transitory computer-readable medium, e.g., a flash memory, ROM, RAM, or other memory.

At stage 501 of the illustrated process 500, the devices 200, 201 are not docked together and thus operate independently. The devices 200, 201 are mated at stage 503, an occurrence that is subsequently detected at stage 505 by the first device 200. In particular, for example, the first device 200 may detect the presence of the second device 201 via its connectivity at the first device's contact array 213. Alternatively, the first device 200 may detect the second device 201 via a capacitance change, near field reaction, or otherwise.

Having detected that the second device 201 has docked to the first device 200, the first device 200 reads an ID value from the second device at stage 507. The ID value of the second device 201 may be periodically broadcast by the second device 201. In an alternative embodiment, the second device 201 is prompted by the first device 200 to send its ID to the first device 200. In another alternative embodiment, the second device 201 detects the docking event as well, and self-initiates a transmission of its ID.

Regardless, the first device 200 resolves the ID of the second device 201 to a predetermined audio configuration at stage 509, and applies the identified predetermined audio configuration at the final stage of the process 500 (stage 511). In an embodiment of the disclosed principles, the predetermined audio configuration is resolved via a table linking multiple possible IDs to multiple predetermined audio configurations. However, in an alternative embodiment, the ID itself provides the predetermined audio configuration information, either in clear or coded form.

As noted in overview above, the predetermined audio configuration includes one or more audio settings for controlling the usage of speakers and microphones on one or both devices 200, 201. Examples using the devices illustrated herein include disabling a rear facing noise cancellation microphone on the first device 200 while enabling a rear facing noise cancellation microphone on the second device 201, disabling one or more loudspeakers on the first device 200 for speakerphone mode while enabling one or more loudspeakers on the second device 201, and modifying playback frequencies for the loudspeakers to direct high frequencies to the loudspeakers of one device (e.g., the second device 201) and to direct low frequencies to the loudspeakers of the other device (e.g., the first device 200).

It should be noted that the second device 201 may be any one of multiple available device types. For example, while FIGS. 2, 3 and 4 illustrate the second device 201 as providing an extended camera function, an alternative extended functionality module may be used without departing from the scope of the described principles. For example, the second device 201 may provide enhanced audio or visual functions, enhanced memory resources or enhanced power resources. Moreover, the first and second devices 200, 201 need not be formed or configured precisely as described in the foregoing examples, and various device behavior modifications may be made, including or instead of those disclosed above.

It will be appreciated that a system and method for audio configuration in a modular portable device environment have been disclosed herein. However, in view of the many possible embodiments to which the principles of the present disclosure may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. A method of modifying an audio configuration of a combined device comprising a first independently operable device and a second independently operable device, the method comprising:
detecting a docking of the second device to the first device;
detecting a device ID of the second device at the first device;
resolving the device ID to a predetermined audio configuration at the first device for the combined device; and
applying the resolved predetermined audio configuration to the combined device.

2. The method in accordance with claim 1, wherein detecting a docking of the second device to the first device comprises detecting contact of the first and second devices at the first device.

3. The method in accordance with claim 1, wherein detecting a device ID of the second device at the first device comprises receiving a signal at the first device from the second device, the signal containing the device ID of the second device.

4. The method in accordance with claim 1, wherein resolving the device ID to a predetermined audio configuration comprises using an ID table to link the device ID to the predetermined audio configuration.

5. The method in accordance with claim 1, wherein resolving the device ID to a predetermined audio configuration comprises deriving the predetermined audio configuration from the device ID.

6. The method in accordance with claim 1, wherein applying the resolved predetermined audio configuration to the combined device comprises modifying an audio setting of at least one of the first and second devices.

7. The method in accordance with claim 1, wherein the predetermined audio configuration specifies the role of one or more of a loudspeaker, an earpiece speaker and a microphone.

8. The method in accordance with claim 7, wherein the predetermined audio configuration specifies that a noise cancellation microphone of the second device is used by the first device instead of a noise cancellation microphone of the first device.

9. The method in accordance with claim 7, wherein the predetermined audio configuration specifies a type of audio signal to be sent to one or more loudspeakers.

10. The method in accordance with claim 7, wherein the predetermined audio configuration specifies that a loudspeaker of the second device is used by the first device instead of a loudspeaker of the first device.

11. A portable electronic device configured to mate to an additional portable electronic device to form a combined device and to automatically adjust a device audio configuration upon mating to the additional portable electronic device, the portable electronic device comprising: a connector array for electrically connecting to the additional portable electronic device;
a loudspeaker and an earpiece speaker;
a noise cancellation microphone; and
a processor configured to detect connection of the additional portable electronic device at the connector array, detect a device ID of the additional portable electronic device upon detecting the connection of the additional portable electronic device, resolve the device ID to a predetermined audio configuration for the combined device and apply the predetermined audio configuration to the combined device.

12. The portable electronic device in accordance with claim 11, wherein the processor is configured to detect a device ID by receiving a signal from the additional portable electronic device containing the device ID.

13. The portable electronic device in accordance with claim 11, wherein the processor is configured to resolve the device ID to a predetermined audio configuration by using an ID table to link the device ID to the predetermined audio configuration.

14. The portable electronic device in accordance with claim 11, wherein the processor is configured to resolve the device ID to a predetermined audio configuration by deriving the predetermined audio configuration from the device ID.

15. The portable device in accordance with claim 11, wherein the processor is configured to apply the resolved predetermined audio configuration to the combined device by modifying an audio setting associated with at least one of the loudspeaker, earpiece speaker and noise cancellation microphone.

16. The portable electronic device in accordance with claim 15, wherein the predetermined audio configuration specifies that a noise cancellation microphone of the additional portable electronic device is used instead of the noise cancellation microphone of the portable electronic device.

17. The portable electronic device in accordance with claim 15, wherein the predetermined audio configuration specifies a type of audio signal to be sent to the loudspeaker.

18. The portable electronic device in accordance with claim 15, wherein the predetermined audio configuration specifies that a loudspeaker of the additional portable electronic device is used by the portable electronic device instead of the loudspeaker of the portable electronic device.

19. A modular portable electronic device system comprising:
a first independently operable portable electronic device;
a second independently operable portable electronic device configured to dock to the first independently operable portable electronic device to form a combined portable electronic device; and
a processor associated with the first independently operable portable electronic device configured to detect docking of the second independently operable portable electronic device, identify the second independently operable portable electronic device and set an audio configuration for the combined portable electronic device based on identifying the second independently operable portable electronic device.

20. The modular portable electronic device system in accordance with claim 19, wherein the first independently operable portable electronic device includes an earpiece speaker, a loudspeaker and a noise cancellation microphone, and wherein the audio configuration includes a setting for one or more of the earpiece speaker, loudspeaker and noise cancellation microphone.
